(19) United States
(12) Patent Application Publication
(10) Pub. No.: US 2020/0063813 A1
(43) Pub. Date: Feb. 27, 2020

(54) FRICTION MEMBER, FRICTION MATERIAL COMPOSITION, FRICTION MATERIAL, AND VEHICLE

(71) Applicant: HITACHI CHEMICAL COMPANY, LTD., Tokyo (JP)

(72) Inventors: Osamu FUJIOKA, Tokyo (JP); Masamichi MITSUMOTO, Tokyo (JP)

(73) Assignee: HITACHI CHEMICAL COMPANY, LTD., Tokyo (JP)

(21) Appl. No.: 16/278,043

(22) Filed: Feb. 15, 2019

(30) Foreign Application Priority Data
Aug. 23, 2018 (JP) 2018-131479A

(51) Int. Cl. F16D 69/02

(52) U.S. Cl. CPC F16D 69/026; F16D 69/023; F16D 2200/0069; F16D 2200/0021; F16D 2200/0052; F16D 2200/003; F16D 2200/0065

(57) ABSTRACT

Provided are: a friction member having a friction material that contains no copper or containing copper in an amount of less than 0.5% by mass in terms of a copper element and has good friction coefficient at normal braking, good abrasion resistance at high speed and high temperature braking, and high stability of the friction coefficient at low speed and low temperature braking; a friction material composition capable of providing the friction material; the friction material; and a vehicle equipped with the friction member or the friction material. The friction member is specifically a friction member having the friction material and a back metal, wherein the friction material contains no copper or contains copper in an amount of less than 0.5% by mass in terms of a copper element and contains zirconium silicate having an average particle size of 0.2 to 0.9 μm.

### FIELD OF THE INVENTION

The present invention relates to a friction member, a friction material composition, a friction material, and a vehicle.

### BACKGROUND OF THE INVENTION

In vehicles such as automobiles, friction materials such as disc brake pads and brake linings are used for braking. These friction materials play a role of braking due to friction with a disc rotor, a brake drum, or the like which is a mating material. For this reason, friction materials are required to have not only an appropriate coefficient of friction (efficacy characteristics) according to the use conditions, but also less braking noise (squealing characteristics), long service life of the friction material (abrasion resistance), and the like.

The friction material is broadly classified as a semi-metallic material containing 30 to 60% by mass of steel fibers as a fiber base material, a low steel material containing less than 30% by mass of steel fibers, and a NAO (Non-Asbestos Organic) material containing no steel fiber. However, friction materials containing trace amounts of steel fibers may also be classified as NAO materials.

NAO materials generally contain copper in powder or fiber state. However, friction materials containing copper, copper alloys, and the like include copper in abrasion powder generated during braking, suggesting the possibility of contaminating rivers, lakes, and the like. For that reason, in California State and Washington State in the United States, a bill prohibiting sales of friction materials containing 5% by mass or more of copper after 2021 and 0.5% by mass or more of copper after 2023 and incorporation into new vehicles has been approved, and to cope with this, the development of NAO materials that contain no copper or that contain a small amount of copper is an urgent task.

The first typical function of copper is addition of thermal conductivity. Since copper has high thermal conductivity, diffusing heat generated during braking from the friction interface suppresses abrasion due to excessive temperature rise.

The second typical function of copper is protection of the friction interface during high temperature braking.

Since copper has high ductility and malleability, it extends to the friction material surface by braking to form a coating film. As a result, abrasion of the friction material at high speed and high temperature braking can be reduced, and stable friction coefficient can be evolved. In addition, since the spreading film of copper makes it easier to hold the grinding material, it is possible to evolve a good friction coefficient even at low speed and low temperature braking.

Accordingly, in order to develop NAO materials containing no copper or a small amount of copper, copper substitution technology is required from the viewpoint of improvement of the thermal conductivity, interface protection, and holding of the grinding material as described above.

Among such movements, several proposals have been made on friction materials containing no copper or a small amount of copper (for example, refer to Patent Literatures 1 to 3).

In recent years, however, another important issue has arisen together with the above problem of copper substitution. This issue is the adaptability to regenerative brakes adopted in electric vehicles (EV) and hybrid cars (HV) which are recently in widespread use. In the conventional hydraulic brake, the driver has finely adjusted the input from the brake pedal to accordingly adjust the braking force of the vehicle. However, in the regenerative brake, since the system side is responsible for a part of the braking, the ratio of braking force (braking load) obtained by friction in the regenerative brake to the conventional hydraulic brake is low, and when the friction coefficient evolved by the friction material changes extremely, problems will arise in control. For example, when the friction coefficient is extremely low, the braking distance becomes too long, which may cause accidents in the worst case. Therefore, in order to increase the accuracy of the regenerative brake, it is extremely important that the friction coefficient evolved by the friction material is stable, even if the braking load is low load (for example, low speed and low temperature braking).

A representative example in which the friction coefficient changes is a friction coefficient decrease at low speed and low temperature braking in a friction material composition substantially containing no copper. In the friction material composition substantially containing no copper, it is difficult to form a transfer film on the surface of a disk rotor at low speed and low temperature braking, so that the grinding material tends to be lost. As a result, the aggressiveness to the disc rotor due to the grinding action and the shear drag force generated between the iron component derived from the disc rotor and the disc rotor are reduced, and thus the friction coefficient tends to decrease as compared with the normal braking load. As a result, the braking distance becomes long as described above, the problem such as decreasing braking force arises, and the driving comfort tends to be impaired.

From such a point of view, Patent Literatures 1 and 2 focus on high thermal conductivity and high temperature lubricity of copper to only supplement the friction characteristics at high speed and high temperature braking, and do not consider the stability of the friction coefficient during braking and other friction characteristics at low speed and low temperature braking.

For example, Patent Literature 1 proposes stabilization of the friction coefficient at high temperature braking and improvement of abrasion resistance by including: instead of copper, 8 to 15% by volume of an inorganic friction modifier (a) having an average particle size of 0.5 to 20 μm and a Mohs hardness of 5 to 8 based on the total amount of the friction material composition; 1 to 3% by volume of a porous inorganic friction modifier (b) having a microporous structure based on the total amount of the friction material composition; 5 to 10% by volume of the carbonaceous lubricant (c); and satisfying the content of (A), (b), and (c) to be a ratio of 1.0≤((a)+(b))/(c)≤2.5. However, since a large amount of lubricant is contained, it is difficult to improve the stability of the friction coefficient at low speed and low temperature braking while holding good friction coefficient at normal braking.

Patent Literature 2 proposes stabilization of the friction coefficient and improvement of the abrasion resistance at normal braking and high speed braking by containing 1 to 10% by weight of alloy fibers having aluminum as a main component and 5 to 20% by weight of hard inorganic particles having an average particle size of 1 to 20 μm and a Mohs hardness of 4.5 or more. However, it is difficult to improve the stability of the friction coefficient at low speed and low temperature braking while holding both good friction coefficient at normal braking and good abrasion resistance at high speed and high temperature braking.

Under such circumstances, in a friction material composition containing no copper and containing potassium titanate having a plurality of convex shapes, with a view to achieving both of high-temperature abrasion resistance and reduction of abnormal noise, a friction material composition containing zirconium silicate having an average particle size of 1 to 2.5 μm has also been proposed (refer to Patent Literature 3).

### CITATION LIST

### Patent Literature

### [Patent Literature 1] Japanese Patent Laid-Open No. 2015-205959

### [Patent Literature 2] Japanese Patent Laid-Open No. 2015-059125

### [Patent Literature 3] Japanese Patent Laid-Open No. 2016-079246

### SUMMARY OF THE INVENTION

As a result of further investigation by the present inventors on Patent Literature 3, zirconium silicate having an average particle size of 1.0 μm has been found to be excellent in both friction coefficient at normal braking and abrasion resistance at high speed and high temperature braking, but to be difficult to improve the stability of the friction coefficient at low speed and low temperature braking.

An object of the present invention is to provide: a friction member having a friction material that contains no copper or containing copper in an amount of less than 0.5% by mass in terms of a copper element and has good friction coefficient at normal braking, good abrasion resistance at high speed and high temperature braking, and high stability of the friction coefficient at low speed and low temperature braking; a friction material composition capable of providing the friction material; the friction material; and a vehicle equipped with the friction member or the friction material.

As a result of intensive investigations, the present inventors have found that the problem can be solved by containing zirconium silicate having a specific average particle size in a friction material, and have completed the present invention. The present invention relates to the following [1] to [31].

[1] A friction member having a friction material and a back metal, wherein the friction material contains no copper or contains copper in an amount of less than 0.5% by mass in terms of a copper element and contains zirconium silicate having an average particle size of 0.2 to 0.9 μm.
[2] The friction member according to the above [1], wherein the maximum particle size of the zirconium silicate is 1.2 μm or less.
[3] The friction member according to the above [1] or [2], wherein the content of the zirconium silicate is 0.1 to 10% by mass based on the total amount of the friction material.
[4] The friction member according to any of the above [1] to [3], wherein the friction material further contains non-acicular titanate.
[5] The friction member according to the above [4], wherein the non-acicular titanate includes at least one selected from the group consisting of potassium titanate, lithium potassium titanate, potassium magnesium titanate, and sodium titanate.
[6] The friction member according to the above [4] or [5], wherein the non-acicular titanate includes at least two titanates.
[7] The friction member according to any of the above [4] to [6], wherein the content of the non-acicular titanate is 15 to 35% by mass based on the total amount of the friction material.
[8] The friction member according to any of the above [1] to [7], wherein the friction material further contains γ-alumina.
[9] The friction member according to the above [8], wherein the γ-alumina includes at least one selected from the group consisting of γ-alumina having an average particle size of 5 to 80 μm and γ-alumina having an average particle size of 100 to 300 μm.
[10] The friction member according to the above [8] or [9], wherein the content of the γ-alumina is 0.1 to 5% by mass based on the total amount of the friction material.
[11] The friction member according to any of the above [1] to [10], wherein the friction material further contains graphite.
[12] The friction member according to any of the above [1] to [11], wherein the friction material further contains at least one selected from the group consisting of inorganic fillers other than the above, organic fillers, fiber base materials, and binders.
[13] The friction member according to any of [1] to [12], wherein the friction member is for a regenerative braking system.
[14] A vehicle equipped with the friction member according to any of the above [1] to [13].
[15] The vehicle according to the above [14], wherein the vehicle is an electric vehicle or a hybrid vehicle equipped with a regenerative braking system.
[16] A friction material composition containing no copper or containing copper in an amount of less than 0.5% by mass in terms of a copper element and containing zirconium silicate having an average particle size of 0.2 to 0.9 μm.
[17] The friction material composition according to the above [16], wherein the maximum particle size of the zirconium silicate is 1.2 μm or less.
[18] The friction material composition according to the above [16] or [17], wherein the content of the zirconium silicate is 0.1 to 10% by mass based on the total amount of the friction material composition.
[19] The friction material composition according to any of the above [16] to [18], further containing a non-acicular titanate.
[20] The friction material composition according to the above [19], wherein the non-acicular titanate includes at least one selected from the group consisting of potassium titanate, lithium potassium titanate, potassium magnesium titanate, and sodium titanate.
[21] The friction material composition according to the above [19] or [20], wherein the non-acicular titanate includes at least two titanates.
[22] The friction material composition according to any of the above [19] to [21], wherein the content of the non-acicular titanate is 15 to 35% by mass based on the total amount of the friction material composition.
[23] The friction material composition according to any of the above [16] to [22], further containing γ-alumina.
[24] The friction material composition according to the above [23], wherein the γ-alumina includes at least one selected from the group consisting of γ-alumina having an average particle size of 5 to 80 μm and γ-alumina having an average particle size of 100 to 300 μm.
[25] The friction material composition according to the above [23] or [24], wherein the content of γ-alumina is 0.1 to 5% by mass based on the total amount of the friction material composition.
[26] The friction material composition according to any of the above [16] to [25], further containing graphite.
[27] The friction material composition according to any of the above [16] to [26], further containing at least one selected from the group consisting of inorganic fillers other than the above, organic fillers, fiber base materials, and binders.
[28] The friction material composition according to any of the above [16] to [27], wherein the friction material composition is for a regenerative braking system.
[29] A friction material containing the friction material composition according to any of the above [16] to [28].
[30] A vehicle equipped with the friction material according to the above [29].
[31] The vehicle according to the above [30], wherein the vehicle is an electric vehicle or a hybrid vehicle equipped with a regenerative braking system.

### Advantageous Effects of Invention

The present invention can provide: a friction member having a friction material that contains no copper or containing copper in an amount of less than 0.5% by mass in terms of a copper element and has good friction coefficient at normal braking, good abrasion resistance at high speed and high temperature braking, and high stability of the friction coefficient at low speed and low temperature braking; a friction material composition capable of providing the friction material; the friction material; and a vehicle equipped with the friction member or the friction material.

The friction member, the friction material, and the friction material composition of the present invention contain no copper or contain copper in an amount of less than 0.5% by mass in terms of a copper element, and thus they are substantially free of copper and are environmentally friendly.

The present invention can be applied to an electric vehicle or a hybrid vehicle equipped with a regenerative braking system.

### DETAILED DESCRIPTION OF THE INVENTION

Hereinafter, the friction member, the friction material composition, the friction material, and the vehicle according to embodiments of the present invention will be described in detail. However, in the following embodiments, the constituent elements are not indispensable unless otherwise specified. The same applies to numerical values and ranges thereof, and does not limit the present invention.

In the numerical ranges described in the present description, the upper limit value or the lower limit value of the numerical range may be replaced by the values shown in Examples. In the present description, when a plurality of substances corresponding to each component in the friction material composition is present, unless otherwise specified, the content of each component in the friction material composition means the content of the sum of a plurality of the substances present in the friction material composition.

An aspect in which the items described in the present description are arbitrarily combined is also included in the present invention.

### [Friction Material and Friction Member]

The friction material according to the present embodiment is a friction material containing no copper or copper in an amount of less than 0.5% by mass in terms of a copper element and containing zirconium silicate having an average particle size of 0.2 to 0.9 μm.

The friction material of the present embodiment contains no copper or copper in an extremely small amount of less than 0.5% by mass in terms of a copper element. Therefore, the friction material of the present embodiment is environmentally friendly.

The above “copper” is a copper element contained in copper such as fibrous and powdery, copper alloy, copper compound, and the like, and the “copper content” is the content based on the total amount of the friction material.

From the viewpoint of suppressing environmental pollution, the content of copper is preferably 0.4% by mass or less, more preferably 0.2% by mass or less, further preferably 0.1% by mass or less, based on the total amount of the friction material, and is particularly preferable not to contain copper.

### [Constituting Component of Friction Material]

The friction material of the present embodiment is preferable to further contain at least one selected from the group consisting of inorganic fillers, organic fillers, fiber base materials, and binders.

Hereinafter, each component contained in the friction material of the present embodiment will be described.

### <Inorganic Filler>

The friction material of the present embodiment preferably contains inorganic fillers. The inorganic filler can evolve a function as a friction modifier for avoiding deterioration of thermal resistance, abrasion resistance, stability of the friction coefficient, and the like of the friction material. Here, in the present invention, the inorganic fillers do not include fibrous fillers (that is, inorganic fibers described below).

Since the hardness of the disk rotor as a mating material generally corresponds to cast iron having a Mobs hardness of about 4.5, the inorganic filler having a Mohs hardness of 5 or more acts as a grinding material and has an effect of increasing the friction coefficient.

In the present invention, zirconium silicate having an average particle size of 0.2 to 0.9 μm is an essential component, but it is also preferable to contain other inorganic fillers.

The inorganic filler may be used singly, or in combination of two or more.

### (Zirconium Silicate)

Zirconium silicate has a high Mobs hardness of 6 to 7.5 which is effective for evolving the friction coefficient by grinding and can function as a so-called grinding material. Here, Mobs hardness is measured by comparing scratchability with “standard substance with Mohs hardness of 1 to 10,” and so on.

In the present invention, from the viewpoint of forming a friction material having good friction coefficient at normal braking, good abrasion resistance at high speed and high temperature braking, and high stability of the friction coefficient at low speed and low temperature braking, zirconium silicate (hereinafter sometimes referred to as zirconium silicate A) having an average particle size of 0.2 to 0.9 μm is essential, but other zirconium silicate may be used together as long as the effect of the present invention is not impaired.

Unless otherwise specified, “average particle size” in the present description means a median diameter (D50), which is a value measured by a method such as laser diffraction particle size distribution measurement, and more specifically, the measuring method described in Examples can be adopted. The measuring apparatus is not particularly limited, and for example, a laser diffraction/scattering type particle size distribution measuring apparatus, product name: MT-3300 (manufactured by Microtrack Bell Co., Ltd.) can be used.

The average particle size of zirconium silicate A is preferably 0.3 to 0.8 μm, more preferably 0.3 to 0.7 μm, and furthermore preferably 0.4 to 0.6 μm, from the viewpoint of the stability of the friction coefficient at low speed and low temperature braking, the friction coefficient at normal braking, and the abrasion resistance at high speed and high temperature braking. Particularly, when the average particle size of zirconium silicate exceeds 0.9 μm, the stability of the friction coefficient at low speed and low temperature braking is lowered. It is difficult to produce zirconium silicate having an average particle size of less than 0.3 μm.

The maximum particle size of zirconium silicate A is preferably 1.2 μm or less, and more preferably 1.1 μm or less, from the viewpoint of forming a friction material having good friction coefficient at normal braking, good abrasion resistance at high speed and high temperature braking, and high stability of the friction coefficient at low speed and low temperature braking.

The maximum particle size can be measured using a method such as laser diffraction particle size distribution measurement. As the measuring apparatus, for example, a laser diffraction/scattering type particle size distribution measuring apparatus, product name: MT-3300 (manufactured by Microtrac Bell Co., Ltd.) can be used.

The content of zirconium silicate A is preferably 0.1 to 10% by mass, more preferably 1 to 10% by mass, furthermore preferably 2 to 10% by mass, particularly preferably 2 to 8% by mass, and most preferably 3 to 6.5% by mass based on the total amount of the friction material, from the viewpoint of forming the friction material having good friction coefficient at normal braking, good abrasion resistance at high speed and high temperature braking, and high stability of the friction coefficient at low speed and low temperature braking.

In the case that the friction material of the present embodiment contains zirconium silicate other than zirconium silicate A, the content thereof is preferably adjusted so that the total amount of zirconium silicate containing zirconium silicate A is 0.1 to 10% by mass, from the viewpoint of suppressing an excessive increase in aggressiveness to a disc rotor as a mating material while maintaining the effect of the present invention.

### (Non-Acicular Titanate)

The friction material of the present embodiment preferably contains non-acicular titanate (hereinafter sometimes simply referred to as titanate) as an inorganic filler, from the viewpoint of abrasion resistance at high speed and high temperature braking. As the titanate, non-acicular titanate is used from the viewpoint of human body harmfulness. Non-acicular titanate means plate-shaped titanate having a shape such as a polygon, a circle, and an ellipse, an irregularly shaped titanate, and the like. The shape of titanate can be analyzed by, for example, scanning electron microscope (SEM) observation.

Since the titanate has a low Mohs hardness of about 4 and a relatively high melting point of 1000° C. or more, it is possible to reduce an increase in abrasion of the friction material by intervention of the titanate in the friction interface at high speed and high temperature braking.

The titanate is not particularly limited, but is preferable to include at least one selected from the group consisting of potassium titanate (potassium 6-titanate and potassium 8-titanate), lithium potassium titanate, potassium magnesium titanate, and sodium titanate. Non-acicular titanate may be used singly and preferably contains at least two types of titanate, and is more preferably used in combination of two types of titanate, from the viewpoint of balancing the friction coefficient at normal braking and the abrasion resistance at high speed and high temperature braking at a high level.

As the titanate, potassium titanate and lithium potassium titanate are preferable and are more preferably used in combination, from the viewpoint of abrasion resistance.

The average particle size of the titanate is not particularly limited, but is preferably 1 to 50 μm, more preferably 1.5 to 40 μm, further preferably 2.0 to 20 μm, particularly preferably 2.0 to 10 μm, and most preferably 2.0 to 5.0 μm.

When the friction material of the present embodiment contains non-acicular titanate, its content based on the total amount of the friction material is preferably 15 to 35% by mass, more preferably 20 to 35% by mass, furthermore preferably 23 to 33% by mass, and particularly preferably 25 to 30% by mass. When the titanate content is equal to or more than the lower limit value, the friction coefficient at high speed and high temperature braking tends to be good, and when the content is equal to or less than the upper limit value, suppressing the reduction of the friction coefficient at low speed and low temperature braking tends to be possible.

### (γ-Alumina)

The friction material of the present embodiment preferably contains γ-alumina as an inorganic filler. Since γ-alumina has a Mohs hardness of about 6, it can function effectively as a grinding material. However, not only γ-alumina and but also the zirconium silicate A are included in the friction material to penetrate the layer in which the abrasion powder is deposited or the transfer film of the organic component derived from the friction material, tending to obtain a synergistic effect of increasing the stabilizing effect of the friction coefficient at low speed and low temperature braking.

The average particle size of γ-alumina is not particularly limited, but may be appropriately selected in the range of 5 to 300 μm, preferably 100 to 300 μm, and more preferably 150 to 250 μm, from the viewpoint of further improving abrasion resistance at high temperature and high speed braking.

In one aspect, the γ-alumina may contain at least one selected from the group consisting of γ-alumina having an average particle size of 5 to 80 μm and γ-alumina having an average particle size of 100 to 300 μm. When γ-alumina having an average particle size of 5 to 80 μm and γ-alumina having an average particle size of 100 to 300 μm are used in combination, the maximum of the peak of the particle size distribution of γ-alumina exists in both of 5 to 80 μm and 100 to 300 μm, and hereinafter, the same way of thinking can be made when two having different average particle sizes are used in combination. Here, the maximum of the peak of the particle size distribution is a position where the frequency reaches the maximum value in the peak of the top peaks in the peak in the particle size distribution (volume basis) represented as frequency.

The γ-alumina having an average particle size of 5 to 80 μm is preferably γ-alumina having an average particle size of 10 to 50 μm, and more preferably γ-alumina having an average particle size of 10 to 30 μm. The γ-alumina having an average particle size of 100 to 300 μm is preferably γ-alumina having an average particle size of 130 to 270 μm, more preferably γ-alumina having an average particle size of 150 to 250 μm, furthermore preferably γ-alumina having an average particle size of 170 to 230 μm, and particularly preferably γ-alumina having an average particle size of 185 to 215 μm.

When the friction material of the present embodiment contains γ-alumina, its content based on the total amount of the friction material is preferably 0.1 to 5% by mass, more preferably 0.3 to 3% by mass, furthermore preferably 0.4 to 3% by mass, and particularly preferably 0.7 to 2.5% by mass. At the lower limit value or more, a synergistic effect of stabilizing the friction coefficient at low speed and low temperature braking tends to be obtained and the abrasion resistance at high temperature and high speed braking tends to further improve; at the upper limit value or less, the stability of the friction coefficient at low speed and low temperature braking tends to further improve, and the friction coefficient at normal braking also tends to improve.

### (Graphite)

The friction material of the present embodiment preferably contains graphite as an inorganic filler. Containing graphite can add more excellent thermal conductivity to the friction material. Graphite is not particularly limited, and any known graphite, that is, natural graphite or artificial graphite can be used.

The average particle size of graphite is not particularly limited, but is preferably 1 to 50 μm, more preferably 2 to 30 μm, further preferably 2 to 20 μm, particularly preferably 2 to 10 μm, and most preferably 4 to 10 μm. Graphite having different average particle sizes may be used in combination of two or more.

When the friction material of the present embodiment contains graphite, its content based on the total amount of the friction material is preferably 0.5 to 10% by mass, more preferably 1 to 8% by mass, furthermore preferably 2 to 8% by mass, and particularly preferably 4 to 6% by mass.

When the average particle size and content of graphite are in the above ranges, good thermal conductivity and retention of the friction coefficient tend to be compatible with each other.

### (Grinding Material)

The friction material of the present embodiment may contain triiron tetroxide, triiron dioxide, bismuth oxide, zirconium oxide, or the like as a grinding material. Of these grinding materials, zirconium oxide is preferable.

The average particle size of zirconium oxide is not particularly limited, but is preferably 0.1 to 15 μm, more preferably 0.5 to 10 μm, and furthermore preferably 1 to 5 μm.

When the friction material of the present embodiment contains zirconium oxide, its content based on the total amount of the friction material is preferably 10 to 35% by mass, more preferably 15 to 25% by mass, and furthermore preferably 17 to 23% by mass. The content of zirconium oxide is the above lower limit value or more, tending to provide excellent abrasion resistance and effect of holding the friction coefficient, and the content of zirconium oxide is the above upper limit value or less, tending to capable of suppressing the reduction of the friction coefficient.

### (Other Inorganic Filler)

Other inorganic fillers include magnesium oxide, antimony trisulfide, zirconium hydroxide, tin sulfide, molybdenum disulfide, bismuth sulfide, zinc sulfide, iron sulfide, calcium hydroxide, calcium oxide, sodium carbonate, calcium carbonate, magnesium carbonate, barium sulfate, coke, α-alumina, mica, vermiculite, calcium sulfate, mullite, chromite, titanium oxide, zinc oxide, silica, and the like. Of these inorganic fillers, antimony trisulfide, tin sulfide, mica, calcium hydroxide, and barium sulfate are preferable, and antimony trisulfide, calcium hydroxide, and barium sulfate are more preferable. For these inorganic fillers, common ones used for friction materials can be used.

The average particle size of the antimony trisulfide is not particularly limited, but is preferably 5 to 110 μm, more preferably 7 to 90 μm, and furthermore preferably 10 to 70 μm. When the friction material of the present embodiment contains antimony trisulfide, its content based on the total amount of the friction material is preferably 0.2 to 4% by mass, more preferably 1.0 to 3.5% by mass, and furthermore preferably 1.0 to 2.5% by mass. The content of antimony trisulfide is within this range, tending to provide excellent abrasion resistance, to allow to avoid generation of a mass of metal abrasion powder on the surface of the friction material, called metal catch, to allow to reduce the amount of abrasion of the disc rotor and the friction material, and to suppress the occurrence of squealing of the brake.

Of the above inorganic fillers, calcium hydroxide, calcium oxide, sodium carbonate, and zinc oxide are preferable, from the viewpoint of suppressing rust generation of the friction material. However, since calcium hydroxide, calcium oxide, and sodium carbonate tend to increase the pH of the friction material and readily decompose aramid fibers, it is preferable to pay attention to the amount used so that the pH does not become too high when used with aramid fibers; and for example, when calcium hydroxide is contained as an inorganic filler, the content of calcium hydroxide based on the total amount of the friction material is preferably 0.5 to 10% by mass, more preferably 1 to 8% by mass, and furthermore preferably 2 to 5% by mass.

The average particle size of the calcium hydroxide is not particularly limited, but is preferably 1 to 70 μm, more preferably 3 to 60 μm, and furthermore preferably 5 to 50 μm.

The average particle size of the barium sulfate is not particularly limited, but is preferably 1 to 100 μm, more preferably 5 to 75 μm, and furthermore preferably 10 to 50 μm. The barium sulfate serves as a simple filler for adjusting the volume of the friction material. That is, the content of barium sulfate depends on the content of other components, and the remainder for adjusting an amount of the friction material composition to be a predetermined amount can be supplemented with barium sulfate.

When the friction material of the present embodiment contains “another inorganic filler,” the total content thereof based on the total amount of the friction material is preferably 12 to 50% by mass, more preferably 15 to 40% by mass, further preferably 20 to 40% by mass, and particularly preferably 25 to 40% by mass.

The total content of the inorganic filler in the friction material of the present embodiment based on the total amount of the friction material is preferably 50 to 85% by mass, more preferably 60 to 80% by mass, and furthermore preferably 65 to 75% by mass.

### <Organic Filler>

The friction material of the present embodiment preferably contains an organic filler. The organic filler is included as a friction modifier for improving the sound vibration performance, abrasion resistance, and the like of the friction material. Here, in the present invention, the organic filler does not include fibrous fillers (that is, organic fibers described below).

The organic filler may be used singly or in combination of two or more.

Examples of the organic filler include cashew dust, a rubber component, and the like.

An example of the cashew dust may be cashew dust usually used as a friction material, the cashew dust obtained by polymerizing cashew nut shell oil, curing, and pulverizing it. The cashew dust is preferably unmodified cashew dust.

The average particle size of the cashew dust is not particularly limited, but is preferably 50 to 600 μm, more preferably 70 to 550 μm, further preferably 100 to 550 μm, and particularly preferably 150 to 500 μm.

When the friction material of the present embodiment contains cashew dust, its content based on the total amount of the friction material is preferably 2 to 16% by mass, more preferably 3 to 14% by mass, furthermore preferably 4 to 12% by mass, and particularly preferably 4 to 8% by mass.

The content of cashew dust is in the above range, allowing to improve the sound vibration performance such as squealing due to low elasticity of the friction material.

As the rubber component, a known rubber used for a friction material can be used, and examples thereof include tire rubber, acrylic rubber, isoprene rubber, NBR (nitrile butadiene rubber), SBR (styrene butadiene rubber), and the like.

When the friction material of the present embodiment contains a rubber component, its content based on the total amount of the friction material is preferably 0.2 to 10% by mass, more preferably 0.5 to 5% by mass, more preferably 0.5 to 3% by mass, and particularly preferably 1 to 3% by mass.

The friction material of the present embodiment preferably contains one or more selected from the group consisting of cashew dust and rubber components, and cashew dust and rubber components are more preferably used in combination. When cashew dust and rubber components are used in combination, the cashew dust coated with a rubber component may be used, and cashew dust and rubber components may be blended separately from the viewpoint of the sound vibration performance.

When the friction material of the present embodiment contains an organic filler, the total content thereof based on the total amount of the friction material is preferably 2 to 20% by mass, more preferably 4 to 15% by mass, further preferably 4 to 12% by mass, particularly preferably 6 to 10% by mass.

The content of the organic filler is in the above range, tending to improve the sound vibration performance such as squeal due to low elasticity of friction material and tending to allow to avoid deterioration of thermal resistance and strength reduction due to thermal hysteresis.

### <Fiber Base Material: Organic Fiber and Inorganic Fiber>

A fiber base material shows reinforcing action. The fiber base material includes organic fibers and inorganic fibers. The fiber base material may be used singly or in combination of two or more.

### —Organic Fiber—

An organic fiber is a fibrous material containing an organic substance as a main component.

Examples of the above organic fiber include hemp, cotton, aramid fiber, cellulose fiber, acrylic fiber, phenol resin fiber (having a cross-linked structure), and the like.

The organic fiber may be used singly or in combination of two or more.

As the organic fiber, aramid fiber is preferable, from the viewpoint of thermal resistance. From the viewpoint of improving the strength of the friction material, a fibrillated organic fiber is preferably contained, and a fibrillated aramid fiber is more preferably contained as the organic fiber. The fibrillated organic fiber is an organic fiber which is fiberized and has fluff and is commercially available. Obviously, the friction material composition for the back material of the present invention may contain not only the fibrillated organic fiber and but also other organic fibers.

When the friction material of the present embodiment contains organic fibers, its content based on the total amount of the friction material is not particularly limited, but is preferably 1 to 15% by mass, more preferably 1 to 10% by mass, furthermore preferably 1.5 to 6% by mass, and particularly preferably 1.5 to 4% by mass. When the content is 1% by mass or more, the durability of the backplate after repetitive braking tends to increase, and when the content is 15% by mass or less, the reduction in strength of the back material itself tends to be avoided.

### —Inorganic Fiber—

An inorganic fiber can evolve the effect of improving the mechanical strength and abrasion resistance of the friction material.

Examples of the inorganic fiber include glass fiber, fibrous wollastonite, metal fiber, mineral fiber, carbon fiber, ceramic fiber, biodegradable ceramic fiber, rock wool, potassium titanate fiber, silica alumina fiber, flame-resistant fiber, and the like.

The inorganic fiber is preferably a fibrous material containing an inorganic substance other than a metal and a metal alloy as a main component, and more preferably a mineral fiber.

The inorganic fiber may be used singly or in combination of two or more.

The above mineral fiber is an artificial inorganic fiber obtained by melt spinning of a blast furnace slag such as slag wool, basalt such as basalt fiber, other natural rock, and the like as a main component. Examples of the mineral fiber include mineral fibers containing SiO₂, Al₂O₃, CaO, MgO, FeO, Na₂O, and the like or mineral fibers containing one or two or more of these compounds. The mineral fiber is preferably a mineral fiber containing aluminum element, more preferably a mineral fiber containing Al₂O₃, and furthermore preferably a mineral fiber containing Al₂O₃ and SiO₂.

As the average fiber length of the mineral fiber contained in the friction material increases, the shear strength tends to decrease. Therefore, the average fiber length of the mineral fiber is preferably 500 μm or less, more preferably 100 to 400 μm, furthermore preferably 120 to 340 μm. The average fiber diameter (diameter) of the mineral fiber is not particularly limited, but is typically 1 to 20 μm, and may be 2 to 15 μm.

In the present description, each of the average fiber length and the average fiber diameter is obtained by randomly selecting 50 inorganic fibers to be used and measuring the fiber length and fiber diameter with an optical microscope, and shows the average value obtained therefrom, whereas catalog values can be used as reference when the inorganic fiber is a commercially available product. In the present description, the fiber diameter refers to the diameter of the fiber.

The mineral fiber is preferably biosoluble from the viewpoint of toxicity to the human body. The biosoluble mineral fiber as used herein is a mineral fiber that is partially decomposed in a short time and discharged outside the body even when taken into a human body. Specifically, the biosoluble mineral fiber is a fiber (refer to Nota Q (excluded from carcinogenicity) in EU Directive 97/69/EC) having a chemical composition of 18% by mass or more of the total amount of alkali oxide and alkaline earth oxide (the total amount of oxides of sodium, potassium, calcium, magnesium, and barium), and satisfying any of the following (a), (b), (c), or (d):

(a) in vivo durability test by short-term inhalation exposure, the half-life of fibers with a length of more than 20 m is less than 10 days;

(b) in vivo durability test by short-term intratracheal instillation, the half-life of fibers with a length of more than 20 μm is less than 40 days;

(c) no significant carcinogenicity in the intraperitoneal administration test; or

(d) no pathological findings or tumorigenesis associated with carcinogenicity in the long-term inhalation exposure test. Examples of such a biosoluble mineral fiber include SiO₂—Al₂O₃—CaO—MgO—FeO (—K₂O—Na₂O) fiber and the like and mineral fibers containing at least two selected from SiO₂, Al₂O₃, CaO, MgO, FeO, K₂O, and Na₂O in an arbitrary combination.

When the friction material of the present embodiment contains an inorganic filler (for example, mineral fiber), its content based on the total amount of the friction material is preferably 2 to 30% by mass, more preferably 2 to 20% by mass, further preferably 2 to 10% by mass, and particularly preferably 3 to 8% by mass.

### <Binder>

The friction material of the present embodiment further preferably contains a binder. The binder integrates the organic filler, the fiber base material, and the like contained in the friction material to provide strength.

The binder may be used singly or in combination of two or more.

As the binder, a thermosetting resin used for a friction material can be typically used.

Examples of the thermosetting resin include various modified phenolic resins such as a phenolic resin (for example, straight novolak phenolic resin), an acrylic rubber modified phenolic resin, silicone modified phenolic resin, cashew modified phenolic resin, epoxy modified phenolic resin, and alkylbenzene modified phenolic resin. Of these resins, a phenolic resin (for example, straight novolak phenolic resin) and acrylic rubber modified phenolic resin are preferable, and from the viewpoint of flexibility, an acrylic rubber modified phenolic resin may be selected.

When the friction material of the present embodiment contains the binder, its content based on the total amount of the friction material is preferably 4 to 14% by mass, more preferably 6 to 12% by mass, and furthermore preferably 8 to 10% by mass.

The content of the binder is in the above range, tending to allow to suppress reduction in strength of the friction material and tending to allow to suppress deterioration of the sound vibration performance such as squealing due to a decrease in the porosity of the friction material and thus an increase in the elastic modulus.

### <Other Components>

The friction material of the present embodiment may contain other materials other than the above-mentioned components as necessary.

Examples of other materials include metal powder such as zinc powder and aluminum from the viewpoint of improving abrasion resistance and thermal fade characteristics and organic additives such as fluorinated polymers such as polytetrafluoroethylene (PTFE). Of these materials, metal powder may be selected or zinc powder may be selected.

When the friction material of the present embodiment contains the above other materials, its content based on the total amount of the friction material is preferably 5% by mass or less and more preferably 3% by mass or less, and other materials may not be contained.

When the friction material of the present embodiment contains metal powder, its content based on the total amount of the friction material is preferably 0.5 to 8% by mass, more preferably 1 to 5% by mass, and furthermore preferably 1.5 to 3.5% by mass.

### <Method for Manufacturing Friction Material>

The friction material of the present embodiment can be manufactured by a commonly used method.

An example of a method for manufacturing the friction material of the present embodiment includes a manufacturing method in which a friction material composition satisfying the composition of the friction material of the present embodiment is heated and pressure molded. A specific example includes a method in which the friction material composition of the present embodiment described below is mixed uniformly using a mixer such as a Loedige® mixer, pressure kneader, and Eirich® mixer; this mixture was premolded in a mold; the obtained preliminary molded material is molded under the conditions of a molding temperature of 130 to 160° C., a molding pressure of 20 to 50 MPa, and a molding period of 3 to 10 minutes; and the obtained molded material is thermal treated at 180 to 230° C. for 3 to 5 hours. Painting, scorching treatment, polishing treatment, and the like may be performed as necessary.

### <Use of Friction Material>

The friction material of the present embodiment is used, for example, in the following aspects (1) to (3):

(1) structure of a friction material only;

(2) a friction member having a back metal and the friction material of the present embodiment to be a friction surface formed on the back metal; and

(3) in the structure of the above (2), structure in which a primer layer for surface modification for enhancing the adhesion effect of the back metal and an adhesive layer for bonding the back metal and the friction member further intervene between the back metal and the friction member.

Of these, as the above (2) or (3), the friction material of the present embodiment is preferably used as the friction member having the friction material of the present embodiment and the back metal.

The above back metal is used for improving the mechanical strength of the friction member, and examples of this material include metals such as iron and stainless steel and fiber reinforced plastics such as inorganic fiber reinforced plastics and carbon fiber reinforced plastics.

The above primer layer and adhesive layer may be typically used for a friction member such as a brake shoe.

The friction material of the present embodiment is suitable as a friction material for a disc brake pad and a brake lining in an automobile or the like, particularly, an electric car and a hybrid car equipped with a regenerative braking system. The friction material of the present embodiment can also be used as a friction material for clutch facing, electromagnetic brake, holding brake, and the like by the steps of molding of a target shape, processing, pasting, and the like.

Furthermore, the friction material of the present embodiment can evolve excellent rust removing property even in braking at low load and thus is suitable for a brake pad for regenerative braking system. The present invention can also provide passenger cars such as electric vehicles and hybrid cars which are equipped with the regenerative braking system using the friction material of the present embodiment.

### [Friction Material Composition]

The friction material composition according to the present embodiment is a friction material composition containing no copper or copper in an amount of less than 0.5% by mass in terms of a copper element and containing zirconium silicate having an average particle size of 0.2 to 0.9 μm (zirconium silicate A).

The type of each component contained in the friction material composition of the present embodiment and the manufacturing method thereof are explained as the same as those of the friction material of the present embodiment described above, and their suitable aspects are also the same. The suitable range of the content of each component in the friction material composition is the same as the suitable range described for the friction material of the present embodiment, and the content is based on “total amount of friction material composition.”

Furthermore, the present invention also provides a friction material obtained by molding the friction material composition of the present embodiment. The friction material obtained by molding the friction material composition of the present embodiment can be manufactured by, for example, a method of thermocompressing a preliminarily molded body obtained by preliminarily molding the friction material composition of the present embodiment, a method of directly thermocompressing the friction material composition of the present embodiment and using thermal treatment as required to thermally hardening a binder, or the like. Specific manufacturing methods are the same as the method for manufacturing the friction material of the above present embodiment and Examples described below.

### [Vehicle]

The present invention also provides a vehicle equipped with the friction member of the present embodiment. For example, the friction member of the present invention is used for vehicles or the like with disc brake pad, brake lining, clutch facing, electromagnetic brake, holding brake, or the like. Examples of vehicles include automobiles such as large-sized cars, medium-sized cars, ordinary cars, large special vehicles, compact special vehicles, large motorcycles, and ordinary motorcycles.

The vehicle equipped with the friction member of the present embodiment can evolve excellent rust removing property even in braking at low load and thus is particularly suitable for passenger cars such as electric vehicles and hybrid vehicles equipped with the regenerative braking system.

### EXAMPLE

Hereinafter, the friction material and the friction material composition of the present embodiment will be described in more detail with reference to Examples, but the present invention is not limited to these.

The average particle size and the maximum particle size of zirconium silicate were measured by the following method.

### (Measuring Method of Average Particle Size and Maximum Particle Size of Zirconium Silicate)

Using a laser diffraction/scattering type particle size distribution measuring apparatus, trade name: MT-3300 (manufactured by Microtrac Bell Co., Ltd.), the volume-based particle size distribution was measured by a wet method using a water solvent to determine the maximum particle size and to calculate volume average particle size (D50) from the obtained particle size distribution.

### Examples 1 to 7 and Comparative Examples 1 to 7

### [Production of Disc Brake Pad]

Materials were blended according to the blending ratios shown in Table 1 or Table 2 to obtain each of the friction material composition.

This friction material composition was mixed with a Loedige® mixer (manufactured by Matsubo Corporation, trade name: Loedige mixer M20), and this mixture was preliminarily molded by a molding press. The obtained preliminary molded material was heated and pressure molded together with a back metal (made of iron) manufactured by Hitachi Automotive Systems Co., Ltd., using a molding press (manufactured by Sanki Seiko Co., Ltd.) under the conditions of a molding temperature of 145° C., a molding pressure of 45 MPa, and a molding period of 4 minutes. The obtained molded product was thermal treated at 200° C. for 4 hours, polished using a rotary polishing machine, and scorched at 500° C. to obtain a disk brake pad (friction material thickness of 9.5 mm and friction material projection area of 52 cm²).

The details of the various materials used in Examples and Comparative Examples are as follows. The various materials used in Examples and Comparative Examples were the same.

### [Binder]

Resin A (silicone modified phenol resin): Mitsui Chemicals, Inc.

Resin B (acrylic rubber modified phenolic resin): Mitsui Chemicals, Inc.

Resin C (straight novolac phenolic resin): Mitsui Chemicals, Inc.

### [Organic Filler]

Cashew dust

Rubber component: tire rubber powder

### [Fiber Base Material]

### (Organic Filler)

Aramid fiber

### (Inorganic Filler)

Mineral fiber

### [Metal Powder]

Zinc powder

### [Inorganic Filler]

γ-alumina A: average particle size 20 μm

γ-alumina B: average particle size 200 μm

Non-acicular titanate A: potassium titanate

Non-acicular titanate B: lithium potassium titanate

Graphite: average particle size 8 μm

Zirconium oxide

Zirconium silicate A: “A-PAX UF” (average particle size: 0.4 to 0.6 μm, maximum particle size: 1.1 μm) manufactured by Kinsei Matec Corporation

Zirconium silicate B: “MZ 1000 B” (average particle size: 1.0 μm) manufactured by Daiichi Kigenso Kagaku Kogyo Co., Ltd.

Antimony trisulfide

Calcium hydroxide

Barium sulfate

### [Evaluation Test]

For the disc brake pad obtained in each Example, the following performance evaluation was performed using a brake dynamo tester (manufactured by Shinnihon Tokki Co., Ltd.).

In the performance evaluation test, evaluation was performed using a common pin slide collet type caliper and a ventilated disk rotor (FC250 (gray cast iron)) manufactured by KIRIU Corporation at a moment of inertia of 50 kgm².

### (1. Evaluation of Stability of Friction Coefficient (μ) at Low Speed and Low Temperature Braking)

The test environment was under the conditions of 25° C. and a humidity of 30% and the braking at 40 km/h and 0.15 G was performed 1,500 times, and the change ratio of the friction coefficient (φ at 1,500th braking times to the friction coefficient (μ) at 500th braking times was used as an index of “friction coefficient (μ) stability at low speed and low temperature braking.” The stability of the coefficient of friction at low speed and low temperature braking was evaluated according to the following criteria.

A: change ratio of μ is less than ±5% (excellent)
B: change ratio of μ is ±5% or more and less than ±10% (good)
C: change ratio of μ is ±10% or more (inappropriate)

### (2. Evaluation of Friction Coefficient (μ) at Normal Braking)

The test environment was performed under the conditions of 25° C. and a humidity of 30%, and according to JASO C406, the friction coefficient (μ) at 200 km/h and 0.6 G braking (normal braking) in the second effect test was measured and evaluated according to the following criteria.

A: μ is 0.38 or more and less than 0.41 (excellent)
B: μ is 0.35 or more and less than 0.38 (good)
C: μ is less than 0.35 (inappropriate)

### (3. Evaluation of Abrasion Resistance at High Speed and High Temperature Braking)

The test was performed according to JASO C427 and the abrasion amount of the disk pad at the pre-braking temperature of 400° C. was measured in each Example, and the abrasion resistance at high speed and high temperature braking was evaluated according to the following criteria.

A: abrasion amount is less than 0.8 mm (excellent)
B: abrasion amount is 0.8 to 1.2 mm (good)
C: abrasion amount is 1.2 mm or more (inappropriate)

TABLE 1

| | | | Example | | | | | | |
|---|---|---|---|---|---|---|---|---|---|
| | Material | | 1 | 2 | 3 | 4 | 5 | 6 | 7 |
| Friction | Binder | Resin A | 9.0 | 9.0 | 9.0 | 9.0 | 4.5 | 4.5 | 9.0 |
| material | | Resin B | | | | | 4.5 | | |
| composition | | Resin C | | | | | | 4.5 | |
| (% by mass) | Organic filler | Cashew dust | 6.0 | 6.0 | 6.0 | 6.0 | 6.0 | 6.0 | 6.0 |
| | | Rubber component | 2.0 | 2.0 | 2.0 | 2.0 | 2.0 | 2.0 | 2.0 |
| | Fiber base | Copper fiber | | | | | | | |
| | material | Aramid fiber | 2.5 | 2.5 | 2.5 | 2.5 | 2.5 | 2.5 | 2.5 |
| | | Mineral fiber | 5.0 | 5.0 | 5.0 | 5.0 | 5.0 | 5.0 | 5.0 |
| | Metal powder | Zinc powder | 2.5 | 2.5 | 2.5 | 2.5 | 2.5 | 2.5 | 2.5 |
| | Inorganic filler | Zirconium silicate A | 5.0 | 3.5 | 3.5 | 3.5 | 3.0 | 5.0 | 6.0 |
| | | Zirconium silicate B | | | | | | | |
| | | Non-acicular titanate A | 14.0 | 14.0 | 14.0 | 14.0 | 13.0 | 15.0 | 16.0 |
| | | Non-acicular titanate B | 12.0 | 12.0 | 12.0 | 12.0 | 11.0 | 13.0 | 14.0 |
| | | γ-alumina A | | 0.5 | 0.5 | 1.0 | | | |
| | | γ-alumina B | 1.0 | 0.5 | | | 1.0 | 1.0 | 2.0 |
| | | Graphite | 5.0 | 5.0 | 5.0 | 5.0 | 5.0 | 5.0 | 5.0 |
| | | Zirconium oxide | 20.0 | 20.0 | 20.0 | 20.0 | 20.0 | 20.0 | 20.0 |
| | | Antimony trioxide | 2.0 | 2.0 | 2.0 | 2.0 | 2.0 | 2.0 | 2.0 |
| | | Calcium hydroxide | 4.0 | 4.0 | 4.0 | 4.0 | 4.0 | 4.0 | 4.0 |
| | | Barium sulfate | 10.0 | 11.5 | 12.0 | 11.5 | 14.0 | 8.0 | 4.0 |

| | | | | | | | | |
|---|---|---|---|---|---|---|---|---|
| | Total amount | 100.0 | 100.0 | 100.0 | 100.0 | 100.0 | 100.0 | 100.0 |
| Evaluation | 1. Stability of μ at low speed and low | A | A | B | A | A | B | A |
| result | temperature braking | | | | | | | |
| | 2. μ at normal braking | B | B | B | B | A | A | A |
| | 3. Abrasion resistance at high speed | A | B | A | B | B | A | A |
| | and high temperature braking | | | | | | | |

TABLE 2

| | | | Comparative Example | | | | | | |
|---|---|---|---|---|---|---|---|---|---|
| | Material | | 1 | 2 | 3 | 4 | 5 | 6 | 7 |
| Friction | Binder | Resin A | 9.0 | 9.0 | 9.0 | 9.1 | 9.0 | 9.0 | 8.0 |
| material | | Resin B | | | | | | | |
| composition | | Resin C | | | | | 4.5 | | |
| (% by mass) | Organic filler | Cashew dust | 6.0 | 6 | 6.0 | 6.0 | 6.0 | 6.0 | 5.5 |
| | | Rubber component | 2.0 | 2.0 | 2.0 | 2.0 | 2.0 | 2.0 | 1.0 |
| | Fiber base | Copper fiber | | | | | | | 15.0 |
| | material | Aramid fiber | 2.5 | 2.5 | 2.5 | 2.5 | 2.5 | 2.5 | 3.0 |
| | | Mineral fiber | 50 | 5.0 | 5.0 | 5.0 | 5.0 | 5.0 | 5.0 |
| | Metal powder | Zinc powder | 2.5 | 2.5 | 2.5 | 2.5 | 2.5 | 2.5 | 2.5 |
| | Inorganic filler | Zirconium silicate A | | | | | | | |
| | | Zirconium silicate B | 2.0 | 5.0 | 2.0 | 3.5 | 5.0 | 5.0 | 5.0 |
| | | Non-acicular titanate A | 14.0 | 14.0 | 14.0 | 14.0 | 15.0 | 16.0 | 15.0 |
| | | Non-acicular titanate B | 12.0 | 12.0 | 12.0 | 12.0 | 13.0 | 14.0 | |
| | | γ-alumina A | 1.0 | | 0.5 | 1.0 | | | |
| | | γ-alumina B | 1.0 | 1.5 | 0.5 | | 1.0 | 2.0 | |
| | | Graphite | 5.0 | 5.0 | 5.0 | 5.0 | 5.0 | 5.0 | 2.0 |
| | | Zirconium oxide | 20.0 | 20.0 | 20.0 | 20.0 | 20.0 | 20.0 | 9.5 |
| | | Antimony trioxide | 2.0 | 2.0 | 2.0 | 2.0 | 2.0 | 2.0 | 2.0 |
| | | Calcium hydroxide | 4.0 | 4,0 | 4.0 | 4.0 | 4.0 | 4.0 | 1.0 |
| | | Barium sulfate | 12.0 | 9.5 | 13.0 | 11.5 | 3.5 | 5.0 | 25.5 |

| | | | | | | | | |
|---|---|---|---|---|---|---|---|---|
| | Total amount | 100.0 | 100.0 | 100.0 | 100.0 | 100.0 | 100.0 | 100.0 |
| Evaluation | 1. Stability of μ at low speed and low | C | C | C | C | C | C | A |
| result | temperature braking | | | | | | | |
| | 2. μ at normal braking | B | B | A | A | B | B | C |
| | 3. Abrasion resistance at high speed | C | B | A | A | A | B | C |
| | and high temperature braking | | | | | | | |

Examples 1 to 7 show the stability of the friction coefficient at low speed and low temperature braking at the same level as Comparative Example 7 containing copper, and the friction coefficient at normal braking and the abrasion resistance at high speed and high temperature braking became better than Comparative Example 7. Examples 1 to 7 showed that the stability of the friction coefficient at low speed and low temperature braking was excellent as compared with Comparative Examples 1 to 6 containing no zirconium silicate A.

Examples 1 to 4 demonstrated that the abrasion resistance at high temperature and high speed braking was able to be further improved by adjusting the type and content of γ-alumina.

### INDUSTRIAL APPLICABILITY

The friction material, the friction material composition, and the friction member of the present invention evolve good friction coefficient at normal braking, good abrasion resistance at high speed and high temperature braking, and excellent stability of the friction coefficient at low speed and low temperature braking even without using copper that may cause environmental pollution, compared to conventional products, and thus are suitable for electric cars and hybrid cars equipped with a regenerative braking system as well as for general passenger cars.

1. A friction member comprising a friction material and a back metal,
wherein the friction material comprises no copper or comprises copper in an amount of less than 0.5% by mass in terms of a copper element and comprises zirconium silicate having an average particle size of 0.2 to 0.9 μm.

2. The friction member according to claim 1, wherein the maximum particle size of the zirconium silicate is 1.2 μm or less.

3. The friction member according to claim 1, wherein the content of the zirconium silicate is 0.1 to 10% by mass based on the total amount of the friction material.

4. The friction member according to claim 1, wherein the friction material further comprises non-acicular titanate.

5. The friction member according to claim 4, wherein the non-acicular titanate comprises at least one selected from the group consisting of potassium titanate, lithium potassium titanate, potassium magnesium titanate, and sodium titanate.

6. The friction member according to claim 4, wherein the non-acicular titanate comprises at least two titanates.

7. The friction member according to claim 4, wherein the content of the non-acicular titanate is 15 to 35% by mass based on the total amount of the friction material.

8. The friction member according to claim 1, wherein the friction material further comprises γ-alumina.

9. The friction member according to claim 8, wherein the γ-alumina comprises at least one selected from the group consisting of γ-alumina having an average particle size of 5 to 80 μm and γ-alumina having an average particle size of 100 to 300 μm.

10. The friction member according to claim 8, wherein the content of the γ-alumina is 0.1 to 5% by mass based on the total amount of the friction material.

11. The friction member according to claim 1, wherein the friction material further comprises graphite.

12. The friction member according to claim 1, wherein the friction material further comprises at least one selected from the group consisting of inorganic fillers other than the above, organic fillers, fiber base materials, and binders.

13. The friction member according to claim 1, wherein the friction member is for a regenerative braking system.

14. A vehicle equipped with the friction member according to claim 1.

15. The vehicle according to claim 14, wherein the vehicle is an electric vehicle or a hybrid vehicle equipped with a regenerative braking system.

16. A friction material composition comprising no copper or comprising copper in an amount of less than 0.5% by mass in terms of a copper element and comprising zirconium silicate having an average particle size of 0.2 to 0.9 μm.

17. The friction material composition according to claim 16, wherein the maximum particle size of the zirconium silicate is 1.2 μm or less.

18. The friction material composition according to claim 16, wherein the content of the zirconium silicate is 0.1 to 10% by mass based on the total amount of the friction material composition.

19. The friction material composition according to claim 16, further comprising a non-acicular titanate.

20. The friction material composition according to claim 19, wherein the non-acicular titanate comprises at least one selected from the group consisting of potassium titanate, lithium potassium titanate, potassium magnesium titanate, and sodium titanate.

21. The friction material composition according to claim 19, wherein the non-acicular titanate comprises at least two titanates.

22. The friction material composition according to claim 19, wherein the content of the non-acicular titanate is 15 to 35% by mass based on the total amount of the friction material composition.

23. The friction material composition according to claim 16, further comprising γ-alumina.

24. The friction material composition according to claim 23, wherein the γ-alumina comprises at least one selected from the group consisting of γ-alumina having an average particle size of 5 to 80 μm and γ-alumina having an average particle size of 100 to 300 μm.

25. The friction material composition according to claim 23, wherein the content of the γ-alumina is 0.1 to 5% by mass based on the total amount of the friction material composition.

26. The friction material composition according to claim 16, further comprising graphite.

27. The friction material composition according to claim 16, further comprising at least one selected from the group consisting of inorganic fillers other than the above, organic fillers, fiber base materials, and binders.

28. The friction material composition according to claim 16, wherein the friction material composition is for a regenerative braking system.

29. A friction material comprising the friction material composition according to claim 16.

30. A vehicle equipped with the friction material according to claim 29.

31. The vehicle according to claim 30, wherein the vehicle is an electric vehicle or a hybrid vehicle equipped with a regenerative braking system.
